(19) United States
(12) Patent Application Publication
(10) Pub. No.: US 2024/0378285 A1
(43) Pub. Date: Nov. 14, 2024

(54) TRAINING AND DEPLOYING MODELS TO PREDICT CYBERSECURITY EVENTS

(71) Applicant: International Business Machines Corporation, Armonk, NY (US)

(72) Inventors: Shiau Hong Lim, Singapore (SG); Laura Wynter, Singapore (SG)

(21) Appl. No.: 18/196,823

(22) Filed: May 12, 2023

(51) Int. Cl. G06F 21/55; G06F 21/56; G06N 3/08

(52) U.S. Cl. CPC G06F 21/552; G06F 21/554; G06F 21/564; G06N 3/08

(57) ABSTRACT

A computer-implemented method, according to one approach, includes collecting historical event log data from host devices and training a first model to convert textual log events of the historical event log data into event embedding vectors. The method further includes training a second model to classify whether at least some of the event embedding vectors represent abnormal or potentially malicious behavior. The second model is a hierarchical temporal event transformer model. The method further includes deploying the trained first model and the trained second model to predict a likelihood of a malicious cybersecurity event occurring within a first predetermined period of time from a current time. A computer program product, according to another approach, includes a computer readable storage medium having program instructions embodied therewith. The program instructions are readable and/or executable by a computer to cause the computer to perform the foregoing method.

### BACKGROUND

The present invention relates to cybersecurity, and more specifically, this invention relates to deploying a trained first model and a trained second model to predict the likelihood of a malicious cybersecurity event occurring within a first predetermined period of time from a current time.

Networks typically include a plurality of user devices, e.g., computers, processing circuits, cellular phones, etc., that communicate with one another. Malicious actors frequently attempt to gain unauthorized access to user devices that are connected to networks. Specifically, these malicious actors often attempt to gain unauthorized access to user devices connected to a network in order to, e.g., mine private information stored on the devices, compromise processing functionality of the devices, steal monetary funds from accounts that the devices have access to, etc.

In order to protect a device that is exchanging data, e.g., communication packets, audio files, monetary funds, etc., within such a network, the device may itself perform cybersecurity defensive measures and/or rely on a service to perform cybersecurity defensive measures. For example, these cybersecurity defensive measures include, e.g., implementation of multi-step authentication measures, performing scans on the device, restricting communications to only other devices that are verified by a third party, etc. However, cybersecurity incidents are a problem of relatively major concern in that the number of cybersecurity incidents that occur in networks and cybersecurity risks that are present in networks tends to increase each year. This is in part because the number of devices, systems and even everyday objects that are connected via the internet continues to increase. Cyber criminals that develop cybersecurity threats are also becoming relatively more sophisticated over time.

Some conventional cybersecurity defensive measures attempt to mitigate cybersecurity threats, e.g., potential malicious cybersecurity events, by deploying endpoint detection and response (EDR) applications that are configured to monitor information technology (IT) processes in connected systems using so-called sensors. These applications provide a continuous stream of events based on the activities that are monitored by the sensors. Examples of such events include network connection, DNS request, etc. However, these applications struggle to operate efficiently within IT systems of relatively medium to relatively large size because the number of such events can be on the order of gigabytes of data each day. In some other defensive measures, existing systems use rules to classify chronological orderings of events that are indicative of a cybersecurity intrusion and label such a set of events to be a “detection”. However, these measures compromise performance of such systems because such rules are typically static and require time-consuming, manual effort to adapt to changing threat patterns. Existing systems are also not effective at converting low-level information into the sought-after detections. This is because existing systems identify past patterns of incidents, encode them into rules, and apply the rules to IT systems. Cyber criminals constantly adjust tactics. Accordingly, existing systems produce relatively many “false positive” detection alerts, and may miss new cyber intrusions. Accordingly, there is a longstanding need for accurate cybersecurity incident detection techniques. There is a particularly longstanding need for cybersecurity incident detection techniques that enable relatively early detection of cybersecurity threats in order to allow for relatively effective responses thereto, e.g., mitigating the threats before they are successfully able to compromise one or more user devices in a network.

### SUMMARY

A computer-implemented method, according to one approach, includes collecting historical event log data from host devices. Collecting historical event log data from host devices when developing a cybersecurity defensive solution enables relevant information to be considered. This is particularly important in view of the principle that cybersecurity threats may be composed of many of the same key fragments, e.g., at least some properties of cybersecurity threat tactics have some relation with respect to one another. Accordingly, in order to accurately address relatively most recently developed cybersecurity threats in order to prevent malicious cybersecurity events from occurring, the historical event log data is collected from host devices.

The method further includes training a first model to convert textual log events of the historical event log data into event embedding vectors. The event embedding vectors are based on the historical event log data and thereby provide inputs in the form of embedding vectors for a second model to use. The second model is trained to classify whether at least some of the event embedding vectors represent abnormal or potentially malicious behavior. The second model is a hierarchical temporal event transformer model. As a result of training the second model, the second model may be used to classify whether abnormal or potentially malicious behavior is present in an environment that includes the host devices. Such identification occurs ahead of such malicious events occurring, and therefore mitigating operations are able to be performed to prevent performance of the host devices from being compromised.

The trained first model and the trained second model are deployed to predict a likelihood of a malicious cybersecurity event occurring within a first predetermined period of time from a current time. This deployment anticipates malicious cybersecurity events in devices such as the host devices. This way, proactive preparation and defensive operations may be performed to mitigate any anticipated malicious cybersecurity events rather than merely responding to such malicious cybersecurity events after the malicious cybersecurity events are able to gain unauthorized access to the host devices. This preserves processing potential that would otherwise be expended in recovering from the malicious cybersecurity event, and also protects user data that may be stored on the host device.

The first model is trained to use natural language modeling to map tokens of the textual log events of the historical event log data to the event embedding vectors via a lookup table. The event embedding vectors establish inputs in the form of embedding vectors for the second model to use. The first model is a bidirectional encoder representations from transformers (BERT) model, and training the first model includes using masked-language modeling. This training of the first model to convert the textual log events of the historical event log data into the event embedding vectors allows data of logged events to be converted into embeddings. These embeddings provide a field of data that may be manipulated by the second model to determine a summarized sample of data that is used to determine whether a cybersecurity event is likely to occur. These determinations are useful for preparing for and/or even mitigating such cybersecurity events.

The first model is different than the second model, and the second model is trained in two phases. Training of the second model during the first phase includes: determining a subset of the event embedding vectors of the first model to use as training targets, and causing the second model to estimate whether events associated with the training targets will occur within a second predetermined period of time from a current time. Training of the second model during the second phase includes: determining labeled examples, and causing the second model to classify whether each of the labeled examples represent abnormal or potentially malicious behavior. As a result of training the second model in the first and second phases, the second model is configured to be used to classify whether abnormal or potentially malicious behavior is present in an environment that includes the host devices. Such identification occurs ahead of such malicious events occurring, and therefore mitigating operations are able to be performed to prevent performance of the host devices from being compromised.

A first of the labeled examples used to train the second model is based on an anomaly and a second of the labeled examples used to train the second model is based on detected malicious activities. These labeled examples provide the second model with different instances of training data that prepare the second model for anticipating different types of potentially malicious behavior present in an environment that includes the host devices. The second model employs a neural-network architecture. The neural-network architecture may be used to summarize a large number of events, e.g., thousands of events or even tens of thousands of events in some approaches, into an input form that is then processed by a transformer architecture.

Deployment of the trained first model includes causing the trained first model to determine, for each of the host devices, embedding vectors for a recent logged event stream. Deployment of the trained first model furthermore includes generating a two-dimensional matrix that is based on the determined embedding vectors for the recent logged event stream. The deployment of the trained second model includes causing the two-dimensional matrix to be applied to the trained second model to generate a classification output that represents the likelihood, where the classification output is a numerical score of a predetermined range of potential numerical scores. These deployments anticipate malicious cybersecurity events in devices such as the host devices. This way, proactive preparation and defensive operations may be performed to mitigate any anticipated malicious cybersecurity events rather than merely responding to such malicious cybersecurity events after the malicious cybersecurity events are able to gain unauthorized access to the host devices. This preserves processing potential that would otherwise be expended in recovering from the malicious cybersecurity event, and also protects user data that may be stored on the host device.

A computer program product, according to another approach, includes a computer readable storage medium having program instructions embodied therewith. The program instructions are readable and/or executable by a computer to cause the computer to perform the foregoing method.

A system, according to another approach, includes a processor, and logic integrated with the processor, executable by the processor, or integrated with and executable by the processor. The logic is configured to perform the foregoing method.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a plot, in accordance with one approach of the present invention.

FIGS. 4A-4C depict operation sequences, in accordance with several approaches of the present invention.

FIG. 5A-5B are a plot, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for training and deploying models to predict cybersecurity events.

In one general approach, a computer-implemented method includes collecting historical event log data from host devices. Collecting historical event log data from host devices when developing a cybersecurity defensive solution enables relevant information to be considered. This is particularly important in view of the principle that cybersecurity threats may be composed of many of the same key fragments, e.g., at least some properties of cybersecurity threat tactics have some relation with respect to one another. Accordingly, in order to accurately address relatively most recently developed cybersecurity threats in order to prevent malicious cybersecurity events from occurring, the historical event log data is collected from host devices.

The method further includes training a first model to convert textual log events of the historical event log data into event embedding vectors. The event embedding vectors are based on the historical event log data and thereby provide inputs in the form of embedding vectors for a second model to use. The second model is trained to classify whether at least some of the event embedding vectors represent abnormal or potentially malicious behavior. The second model is a hierarchical temporal event transformer model. As a result of training the second model, the second model may be used to classify whether abnormal or potentially malicious behavior is present in an environment that includes the host devices. Such identification occurs ahead of such malicious events occurring, and therefore mitigating operations are able to be performed to prevent performance of the host devices from being compromised.

The trained first model and the trained second model are deployed to predict a likelihood of a malicious cybersecurity event occurring within a first predetermined period of time from a current time. This deployment anticipates malicious cybersecurity events in devices such as the host devices. This way, proactive preparation and defensive operations may be performed to mitigate any anticipated malicious cybersecurity events rather than merely responding to such malicious cybersecurity events after the malicious cybersecurity events are able to gain unauthorized access to the host devices. This preserves processing potential that would otherwise be expended in recovering from the malicious cybersecurity event, and also protects user data that may be stored on the host device.

The first model is trained to use natural language modeling to map tokens of the textual log events of the historical event log data to the event embedding vectors via a lookup table. The event embedding vectors establish inputs in the form of embedding vectors for the second model to use. The first model is a bidirectional encoder representations from transformers (BERT) model, and training the first model includes using masked-language modeling. This training of the first model to convert the textual log events of the historical event log data into the event embedding vectors allows data of logged events to be converted into embeddings. These embeddings provide a field of data that may be manipulated by the second model to determine a summarized sample of data that is used to determine whether a cybersecurity event is likely to occur. These determinations are useful for preparing for and/or even mitigating such cybersecurity events.

The first model is different than the second model, and the second model is trained in two phases. Training of the second model during the first phase includes: determining a subset of the event embedding vectors of the first model to use as training targets, and causing the second model to estimate whether events associated with the training targets will occur within a second predetermined period of time from a current time. Training of the second model during the second phase includes: determining labeled examples, and causing the second model to classify whether each of the labeled examples represent abnormal or potentially malicious behavior. As a result of training the second model in the first and second phases, the second model is configured to be used to classify whether abnormal or potentially malicious behavior is present in an environment that includes the host devices. Such identification occurs ahead of such malicious events occurring, and therefore mitigating operations are able to be performed to prevent performance of the host devices from being compromised.

A first of the labeled examples used to train the second model is based on an anomaly and a second of the labeled examples used to train the second model is based on detected malicious activities. These labeled examples provide the second model with different instances of training data that prepare the second model for anticipating different types of potentially malicious behavior present in an environment that includes the host devices. The second model employs a neural-network architecture. The neural-network architecture may be used to summarize a large number of events, e.g., thousands of events or even tens of thousands of events in some approaches, into an input form that is then processed by a transformer architecture.

Deployment of the trained first model includes causing the trained first model to determine, for each of the host devices, embedding vectors for a recent logged event stream. Deployment of the trained first model furthermore includes generating a two-dimensional matrix that is based on the determined embedding vectors for the recent logged event stream. The deployment of the trained second model includes causing the two-dimensional matrix to be applied to the trained second model to generate a classification output that represents the likelihood, where the classification output is a numerical score of a predetermined range of potential numerical scores. These deployments anticipate malicious cybersecurity events in devices such as the host devices. This way, proactive preparation and defensive operations may be performed to mitigate any anticipated malicious cybersecurity events rather than merely responding to such malicious cybersecurity events after the malicious cybersecurity events are able to gain unauthorized access to the host devices. This preserves processing potential that would otherwise be expended in recovering from the malicious cybersecurity event, and also protects user data that may be stored on the host device.

In another general approach, a computer program product includes a computer readable storage medium having program instructions embodied therewith. The program instructions are readable and/or executable by a computer to cause the computer to perform the foregoing method.

In another general approach, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cybersecurity event classification module of block 150 for training and deploying models to predict the likelihood of a malicious cybersecurity event occurring within a first predetermined period of time from a current time. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

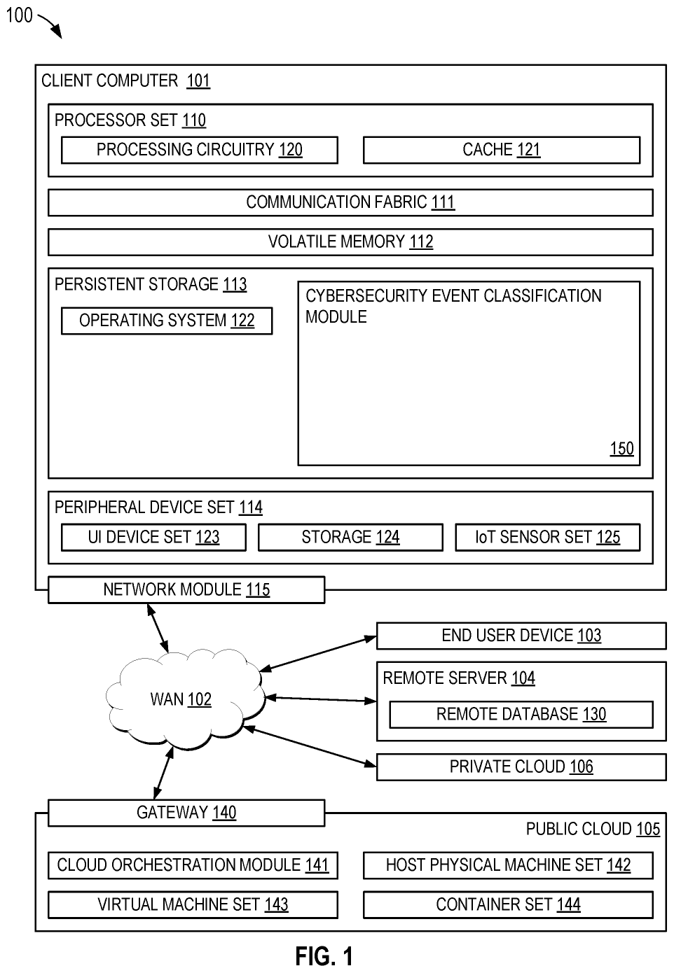

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, networks typically include a plurality of user devices, e.g., computers, processing circuits, cellular phones, etc., that communicate with one another. Malicious actors frequently attempt to gain unauthorized access to user devices that are connected to networks. Specifically, these malicious actors often attempt to gain unauthorized access to user devices connected to a network in order to, e.g., mine private information stored on the devices, compromise processing functionality of the devices, steal monetary funds from accounts that the devices have access to, etc.

In order to protect a device that is exchanging data, e.g., communication packets, audio files, monetary funds, etc., within such a network, the device may itself perform cybersecurity defensive measures and/or rely on a service to perform cybersecurity defensive measures. For example, these cybersecurity defensive measures include, e.g., implementing multi-step authentication measures, performing scans on the device, restricting communications to only other devices that are verified by a third party, etc. However, cybersecurity incidents are a problem of relatively major concern in that the number of cybersecurity incidents that occur in networks and cybersecurity risks that are present in networks tends to increase each year. This is in part because the number of devices, systems and even everyday objects that are connected via the internet continues to increase. Cyber criminals that develop cybersecurity threats are also becoming relatively more sophisticated over time.

Some conventional cybersecurity defensive measures attempt to mitigate cybersecurity threats, e.g., potential malicious cybersecurity events, by deploying endpoint detection and response (EDR) applications that are configured to monitor information technology (IT) processes in connected systems using so-called sensors. These applications provide a continuous stream of events based on the activities that are monitored by the sensors. Examples of such events include network connection, DNS request, etc. However, these applications struggle to operate efficiently within IT systems of relatively medium to relatively large size because the number of such events can be on the order of gigabytes of data each day. In some other defensive measures, existing systems use rules to classify chronological orderings of events that are indicative of a cybersecurity intrusion and label such a set of events to be a “detection”. However, these measures compromise performance of such systems because such rules are typically static and require time-consuming, manual effort to adapt to changing threat patterns. Existing systems are also not effective at converting low-level information into the sought-after detections. This is because existing systems identify past patterns of incidents, encode them into rules, and apply the rules to IT systems. Cyber criminals constantly adjust tactics. Accordingly, existing systems produce relatively many “false positive” detection alerts, and may miss new cyber intrusions. Accordingly, there is a longstanding need for accurate cybersecurity incident detection techniques. There is a particularly longstanding need for cybersecurity incident detection techniques that enable relatively early detection of cybersecurity threats in order to allow for relatively effective responses thereto, e.g., mitigating the threats before they are successfully able to compromise one or more user devices in a network.

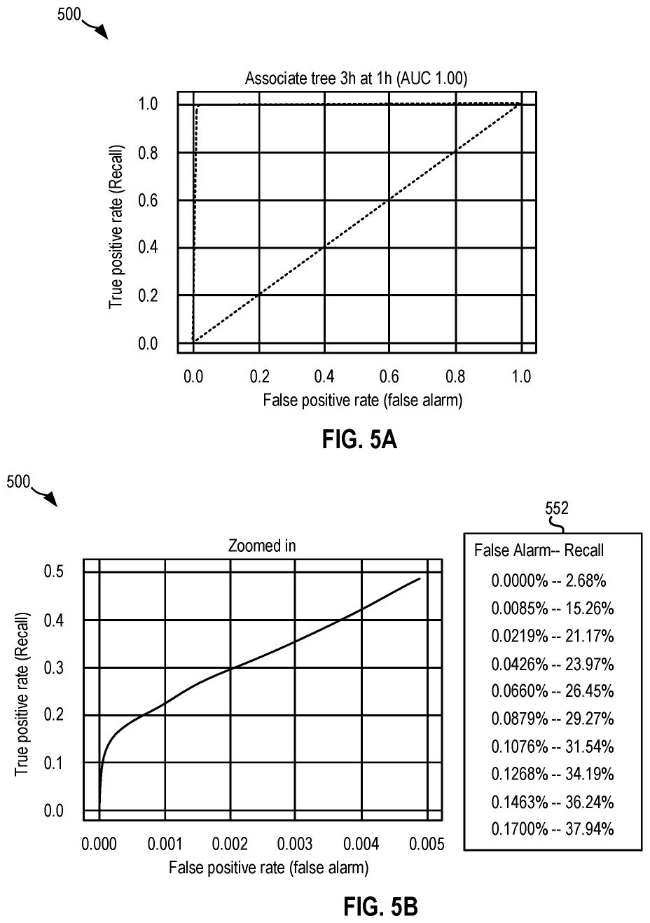

In sharp contrast to the deficiencies of the conventional techniques described above, approaches described herein consider that cyber intrusions evolve in part by hybridization. While the overall pattern of a cybersecurity threat intrusion changes over time as cyber criminals adjust tactics, cybersecurity threats are composed of many of the same key fragments, e.g., at least some properties of cybersecurity threat tactics have some relation with respect to one another. As detailed in various approaches described herein, correlating fragments of past intrusions across each other is important and useful for being able to discover new forms of cyber-attacks. Various approaches described herein also consider that cyber-attacks patterns need not follow the same consecutive order. Randomization of components of an attack often leads to non-detection by conventional rule-based systems. A count-based approach offers one way of remediation. Partial similarity to patterns can be measured and used as a metric which can then be combined to identify a cyber intrusion. For example, the techniques of various approaches described herein use two models combined in an innovative manner in order to mitigate cybersecurity threats. The first model uses natural language modeling to encode and derive causal patterns from the log text into a relatively lower dimensional subspace. The second model uses the encodings of the first model as input to represent the relatively lower-dimensional causal patterns as a function of time that is then used to predict a likelihood of a malicious cybersecurity event occurring. This way, malicious cybersecurity events are relatively accurately anticipated and responded to in such a way that processing resources are preserved, e.g., see FIGS. 5A-5B for relative accuracies.

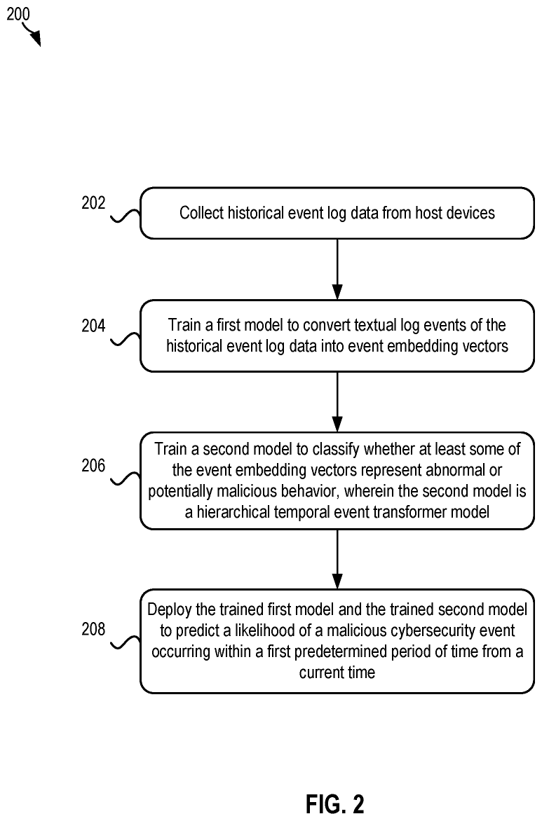

Now referring to FIG. 2, a flowchart of a method 200 is shown, according to one approach. The method 200 may be performed in accordance with the present invention in any of the environments depicted in FIGS. 1-5B among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may be performed in an environment that includes a plurality of devices, e.g., host devices, user devices, servers, etc. In some preferred approaches, the devices include host devices which may be of a type that would become apparent to one of ordinary skill in the art after reading the descriptions herein. Furthermore, in one or more of such preferred approaches, the host devices may include, e.g., a computer, a processing circuit, a server, etc. The environment preferably further includes sensor(s) that are configured to observe processes that are performed by the host devices, and based on such observations, log data associated with the processes from the host devices in an IT monitoring system. In some approaches, the sensors may be of a type that would become apparent to one of ordinary skill in the art after reading the descriptions herein. In some approaches, at least some of the sensors may be sensors of the host devices, e.g., a sensor that is physically integrated into the host device. In some other approaches, at least some of the sensors may not be physically integrated into the host device, but may be configured to monitor the host device and collect information associated with the host device, e.g., have access to a processor of the host device, have access to a memory component of the host device, receive data output by the host device, etc. Accordingly, in some approaches, method 200 includes causing, e.g., instructing, at least one sensor to perform monitoring on host devices. It should be noted that, in preferred approaches, permission is preferably received from the users and/or administrators of the host devices before monitoring is performed on the host devices. Furthermore, subsequent to receiving such permission(s), the users and/or administrators of the host devices are preferably free to suspend and/or revoke the permission(s) at any time and for any reason.

Operation 202 includes collecting historical event log data from host devices. In some preferred approaches, the historical event log data includes data associated with an actor, e.g., such as the host device, and/or a process that the actor is associated with. For context, the process may be a collection of instructions, e.g., an image of executable machine code, that is running in a device and an action of the device may be something that the process is doing. Illustrative examples of actions include, e.g., accessing a critical file, performing a domain name system (DNS) request, attempting to access a website, etc. The collected historical event log data preferably includes information, e.g., metadata, that details one or more of, e.g., timestamp information about the event, an actor of the process, an action and/or sub-actor associated with the event, a domain name associated with the action, an IP address associated with the action, the contents of one or more command lines associated with the process, etc.

In some approaches, the historical event log data may be streams obtained from and/or collected by a type of cybersecurity system, e.g., such as an Endpoint Detection and Response system, that would become apparent to one of ordinary skill in the art after reading the descriptions herein, e.g., CROWDSTRIKE, IBM SECURITY® QRADAR® EDR, etc. In some approaches, these cybersecurity systems may install software and/or hardware sensors on host devices to monitor and record system, application and user activities. These activities trigger a large variety of events, which are logged and sent to, e.g., received at, a central or distributed processing system for further analysis. Furthermore, in some approaches, through automated algorithms as well as human inspections, anomalous or potentially malicious activities are detected and recorded as special alerts or detection events. Operation 202 may, in some approaches, collect information from large volumes of recorded events, both for normal activities as well as anomalous/malicious activities.

Collecting historical event log data from host devices when developing a cybersecurity defensive solution enables relevant information to be considered. This is particularly important in view of the principle that cybersecurity threats may be composed of many of the same key fragments, e.g., at least some properties of cybersecurity threat tactics have some relation with respect to one another. Accordingly, in order to accurately address relatively most recently developed cybersecurity threats in order to prevent malicious cybersecurity events from occurring, the historical event log data is collected from host devices.

As mentioned elsewhere above, the techniques of some preferred approaches described herein include training and deploying a first model and a second model. Techniques for training the first model and the second model are described below.

Operation 204 includes training a first model to convert textual log events of the historical event log data into event embedding vectors. More specifically, the first model may be trained to encode the historical event log data into embedding vectors that are used by the second model. In some preferred approaches, the first model is trained to use natural language modeling to map tokens, e.g., words or sub-words, of the textual log events of the historical event log data to the event embedding vectors via a lookup table. In some approaches, natural language processing (NLP) models and/or self-supervision methods of a type that would become apparent to one of ordinary skill in the art after reading the descriptions herein may be used to learn “embedding vectors” (typically real-valued vectors with a dimension that ranges from a few hundreds to many thousands) that capture both the semantics of natural text, in practically all types of languages. Such embedding vectors may, in some approaches, be trained in a self-supervised manner by simply having access to a large corpus of text.

In some approaches, the first model may be a bidirectional encoder representations from transformers (BERT) model. In one of such approaches, the BERT model may employ a transformer neural-network architecture which may be trained using known masked-language modeling (MLM) techniques. Accordingly, in some approaches, training the first model may include using MLM. More specifically, in some approaches, the first model may be trained to convert textual log events in a causal manner into embeddings (d-dimensional real vectors, e.g. d=768) using self-supervised MLM. In some approaches, during MLM training, the model learns to predict randomly masked words within any given sentence. For context, with respect to approaches described herein, each “sentence” may originate from the historical event log data, which may be extracted from semi-structured event logs, in the following form:

<Timestamp> [Actor]<ActorProperties> . . . [Action]<ActionProperties> . . . .

In the form above, in some approaches, the “Actor” may be a process name, whose properties include the full command line used to launch the process, the user IDs, etc. Furthermore, in some approaches, the “Action” represents the event type associated with the process, such as “Dns-Request” or “Critical-File-Access”, while the action properties include details such as the domain name in dns-request or file name in “critical-file-access”. These “sentences” are then used as a corpus for training the embedding vectors that can turn any log messages into semantically related vectors. For example, in some approaches, each “word” (and/or a “sub-word”) in a sentence may be used as a “token”. The first model may be trained to map each token to an embedding vector through a table-lookup. The token embeddings within a sentence are then averaged into a sentence embedding, e.g., hereafter referred to as an “event embedding vector” and hence each “event” may be converted into an event embedding vector that is used by the second model, e.g., see operation 206. More specifically, training the first model to convert the textual log events of the historical event log data into the event embedding vectors allows data of logged events to be converted into embeddings. These embeddings provide a field of data that may be manipulated by the second model to determine a summarized sample of data that is used to determine whether a cybersecurity event is likely to occur.

Operation 206 includes training a second model to classify whether at least some of the event embedding vectors represent abnormal or potentially malicious behavior. In some approaches, the event embedding vectors are used as input to train a second model. For context, in some approaches, the second model may be a hierarchical temporal event transformer model. For example, in one or more of such approaches, the second model may be caused, e.g., instructed, to employ a neural-network architecture called “transformers”. Even though, in some approaches, the first model may also be a transformer model, it should be noted that the second model is a different model than the first model, e.g., the second model is a separate and different model than the first model. The event embedding vectors from the first model are preferably used as input for the second model. For context, the second model is trained to summarize a large number of events, e.g., thousands of events or even tens of thousands of events in some approaches, into an input form that can be processed by a transformer architecture.

In some approaches, the second model is trained as a temporal-event transformer model using a time series formed by low-dimensional causal event streams with pre-determined time-bins and labels. However, before this processing of the time stamps, the input events for training the second model may include all recorded log events of a given host device over a predetermined time period, e.g., from a last hour, from a last day, from a plurality of previous days, etc. The entire time period is preferably divided in method 200 into time slots of pre-determined length. In some approaches, the entire time period is divided into time slots according to a predetermined time condition, e.g., five minute slots, ten minute slots, fifteen minute slots, etc. All event embedding vectors that fall within the same time slot are then added into a sum embedding vector, resulting in one event embedding vector per time slot. These event embedding vectors are then stacked into a two-dimensional matrix “M”. Techniques for stacking vectors into a two-dimensional matrix that would become apparent to one of ordinary skill in the art after reading the descriptions herein may, in some approaches, be used.

The matrix “M” is, in some approaches, input through a learned initial transformation to generate a transformed matrix. In some approaches, this includes a one-dimensional convolution across time followed by a projection to a target embedding dimension. Each column of the transformed matrix “M′” is treated as a “token” associated with the corresponding time step. The transformed matrix “M′” is then input through the transformer architecture of the second model to obtain the final output. In some preferred approaches, a predetermined type of hierarchical transformer architecture is used for the second model. For example, in some approaches, the second model is a hierarchical attention graph transformer architecture model that builds a hierarchy of different time scales, e.g., from hourly to daily, on top of “M” may be used to capture a relationship across different time scales.

In some approaches, the second model is trained in two different phases, e.g., a first phase and a second phase. Training within the first phase may, in some approaches, be performed in a self-supervised manner where the objective is to predict future events given the input events. In some approaches, training of the second model during the first phase includes determining a subset of the event embedding vectors of the first model to use as training targets. This may include events embeddings vectors determined to have relatively most frequently occurring events (to refine the considered sample of event embedding vectors from a relatively larger dimension of vectors to a relatively smaller dimension of vectors). In some approaches, each target event creates a binary classification task. For example, given a current input “M”, the second model may be instructed to have an objective of predicting whether the target event occurs in a next predetermined period of time, e.g., within a next hour. Accordingly, in some respects, the first phase may be considered a form of pretraining the second model, which may make use of the relatively vast amount of available log data.

The first phase may additionally and/or alternatively include causing, e.g., instructing, the second model to estimate whether events associated with the training targets will occur within a second predetermined period of time from a current time. In some approaches, method 200 includes providing feedback to the second model subsequent to each estimation being made until a determination is made that a predetermined threshold of accuracy is achieved by the second model. In the second phase of training the second model, labeled examples are determined to thereafter use for training the second model. In some preferred approaches, a first of the labeled examples is based on a first portion of the historical event log data that is associated with an anomaly. A second of the labeled examples may be based on detected malicious activities. Method 200 may include causing the second model to classify whether each of the labeled examples represent abnormal or potentially malicious behavior and providing feedback to the model subsequent to each classification being made until a determination is made that a second predetermined threshold (which may or may not be different than the first predetermined threshold) of accuracy is achieved by the second model. This training may be used and thereby results in the second model being trained to classify whether a current input represents abnormal or potentially malicious behavior. For context, a “current input” may be defined as event embedding vectors that are output by the first model once the trained first model and the trained second model are deployed. In some approaches, such event embedding vectors may be generated based on a recent logged event stream, which will be described in greater detail elsewhere below, e.g., see operation 208. Accordingly, the second phase of training the second model is a form of fine-tuning where the pretrained second model, e.g., pretrained during the first phase, is now specialized into predicting imminent threats.

Operation 208 includes deploying the trained first model and the trained second model to predict a likelihood of a malicious cybersecurity event occurring within a first predetermined period of time from a current time, e.g., within a next ten minutes, within a next hour, within a next day, etc. In other words, once the first model and the second model are trained, they may be deployed to anticipate malicious cybersecurity events in devices such as the host devices. This way, proactive preparation and defensive operations may be performed to mitigate any anticipated malicious cybersecurity events rather than merely responding to such malicious cybersecurity events after the malicious cybersecurity events are able to gain unauthorized access to the host devices. This preserves processing potential that would otherwise be expended in recovering from the malicious cybersecurity event, and also protects user data that may be stored on the host device.

In some approaches, deployment of the trained first model includes causing, e.g., instructing, the trained first model to determine, for each of the host devices, embedding vectors for a recent logged event stream. In order to reduce the amount of processing that is performed in generating these embedding vectors during deployment of the trained first model, in some approaches, the “recent” logged event stream may be maintained to a predetermined period of time. For example, in some preferred approaches, the predetermined period of time includes the last two hours before the current time. Deployment of the trained first model may additionally and/or alternatively include generating a two-dimensional matrix “M” that is based on the determined embedding vectors for the recent logged event stream. Note that, in some preferred approaches, the two-dimensional matrix may be generated by stacking vectors into a two-dimensional matrix using techniques that would become apparent to one of ordinary skill in the art after reading the descriptions herein.

Deployment of the trained second model may, in some approaches, include causing an output of the trained first model, e.g., the matrix “M” to be applied to the trained second model to obtain a classification output. For example, in one or more of such approaches, deployment of the trained second model may include causing the two-dimensional matrix to be applied to the trained second model to generate a classification output that represents the likelihood of a malicious cybersecurity event occurring within the first predetermined period of time from a current time. In some preferred approaches, the classification output is a numerical score of a predetermined range of potential numerical scores. For example, in one approach, the predetermined range of potential numerical scores may be from zero to one, where a numerical score of zero represents a relatively lowest likelihood that a malicious cybersecurity event will occur within the first predetermined period of time, and a numerical score of one represents a relatively highest likelihood that a malicious cybersecurity event will occur within the first predetermined period of time. Note that the trained second model may output a numerical score between zero and one, e.g., a fraction, depending on the approach. In some other approaches, the predetermined range of potential numerical scores may include, e.g., one to ten, one to one hundred, etc.

In some approaches, in response to a determination that the predicted likelihood of a malicious cybersecurity event occurring within the first predetermined period of time from the current time exceeds a predetermined threshold, the collecting historical event log data may be considered a signal and/or event of interest. Accordingly, a proactive preparation and/or defensive operation may be performed in order to prevent a malicious cybersecurity event from occurring. In some approaches, the predetermined threshold is, e.g., a value that is in a direct middle of the predetermined range of potential numerical scores, a value that is in a 75th percentile of the predetermined range of potential numerical scores, a value that is in a 95th percentile of the predetermined range of potential numerical scores, etc.

In some approaches, the proactive preparation and/or defensive operations include causing, e.g., instructing at least one of the host devices to implement additional authentication techniques. In another approach, the proactive preparation and/or defensive operations may additionally and/or alternatively include causing, e.g., instructing, a host device to remain offline for a predetermined period of time. Such offline approaches may be particularly applicable for devices that, e.g., have relatively limited processing resources available for recovering from a malicious cybersecurity event, have private user information stored thereon, are determined to have been accessed by unauthorized malicious cybersecurity actors before, etc.

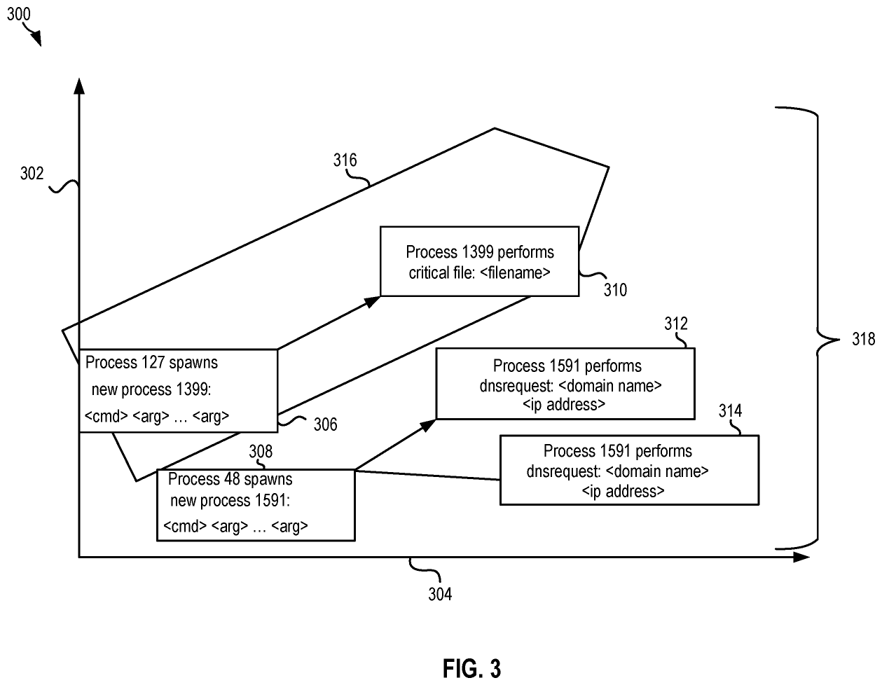

FIG. 3 depicts a plot 300, in accordance with one approach. As an option, the present plot 300 may be implemented in conjunction with features from any other approach listed herein, such as those described with reference to the other FIGS. Of course, however, such plot 300 and others presented herein may be used in various applications and/or in permutations which may or may not be specifically described in the illustrative approaches listed herein. Further, the plot 300 presented herein may be used in any desired environment.

The plot 300 is a graphical representation of observations made by a host and/or device sensor (e.g., see y-axis 302) over time (e.g., see x-axis 304). In some approaches, these observations include processes, e.g., collections of processes 306, 308, 310, 312 and 314. Textual log events of historical event log data based on these processes may be used to determine causal patterns 316. For example, a first model may be trained to use natural language modeling to encode and derive causal patterns from log text into a relatively lower dimensional subspace. A second model is also trained to use the encodings of the first model as input to represent the relatively lower-dimensional causal patterns as a function of time, e.g., see x-axis 304, that may be then used to predict a likelihood of a malicious cybersecurity event occurring. In some preferred approaches, the observations are used as historical event log data 318 to learn from, capture and correlate all observed events as signals for predicting future malicious activities via a hybrid transformer model. For example, at least some of the historical event log data 318 may be applied to one or more operations of method 200 to predict and prevent future malicious activities and/or events.

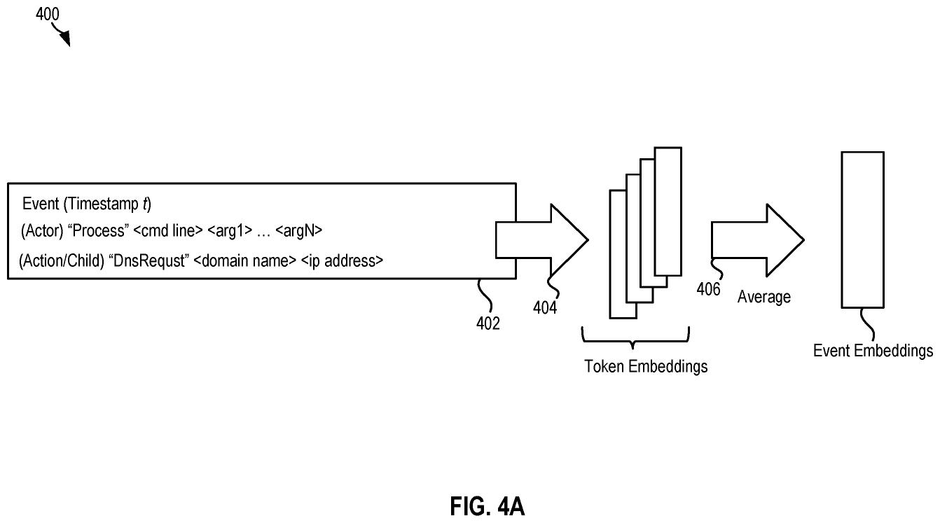

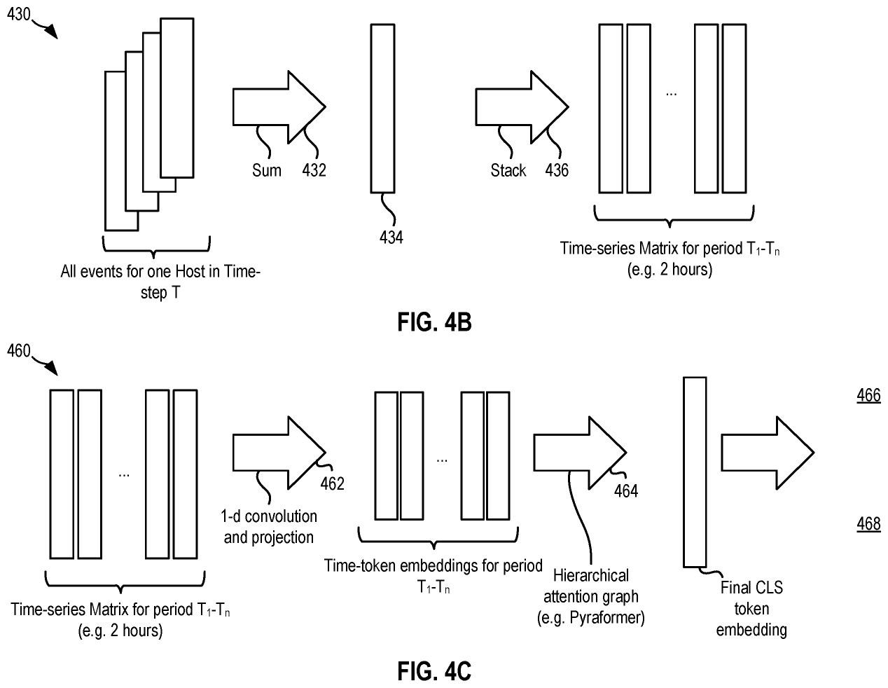

FIGS. 4A-4C depict operation sequences 400, 430 and 460, in accordance with several approaches. As an option, the present operation sequences 400, 430 and 460 may be implemented in conjunction with features from any other approach listed herein, such as those described with reference to the other FIGS. Of course, however, such operation sequences 400, 430 and 460 and others presented herein may be used in various applications and/or in permutations which may or may not be specifically described in the illustrative approaches listed herein. Further, the operation sequences 400, 430 and 460 presented herein may be used in any desired environment.

Referring first to FIG. 4A, operation sequence 400 illustrates textual log events of a historical event log data 402 being converted into event embeddings. In some approaches, a first model may be trained to perform such a conversion. The input for the first model may be event log streams from one or more predetermined cybersecurity systems such as CROWDSTRIKE, IBM SECURITY® QRADAR® EDR, etc., e.g., see operation 404. More specifically, the first model may be trained to convert textual log events in a causal manner into embeddings (d-dimensional real vectors, e.g. d=768) using self-supervised MLM. This process may include generating a plurality of token embeddings that are averaged into an event embedding, e.g., see operation 406.

Referring next to FIG. 4B, operation sequence 430 illustrates that, in some approaches, the input for training a second model during a first phase of the training includes the event embeddings from the first model. Furthermore, operation sequence 430 illustrates that training the second model may be performed using temporal-event transformer models using time series formed by low-dimensional causal event streams, e.g., with predetermined time-bins such as five minute time bins. Specifically, operation 432 includes summing all events for one of the host devices in a time step “T” to obtain a feature vector for time-step “T” 434. In operation 436, the feature vector 434 is stacked to generate a time-series matrix for period T₁-Tₙ.

Now referring to FIG. 4C, operation 460 illustrates that, in some approaches, training the second model in a second phase includes using the network of the first phase of the second model and embeddings from the second model to use temporal-event transformer model and time series formed by low-dimensional causal event streams (with predetermined time-bins e.g. 5-minutes) and labels. In some approaches, the labels identify key detection events from base cybersecurity application as labels for events of interest in training. Operation 462 of operation sequence 460 includes performing a convolution and projection of the time-series matrix for period T₁-Tₙ to generate time-token embeddings for the period T₁-Tₙ. Operation 464 includes applying the time-token embeddings for the period T₁-Tₙ to a hierarchical attention graph, to generate a final classification (CLS) token embedding. The final CLS token embedding may be used for pretraining the second model, e.g., see operation 466, and for detection purposes, e.g., see operation 468 which includes classifying input as “malicious” or “normal”.

FIGS. 5A-5B depict plot 500, in accordance with one approach. As an option, the present plot 500 may be implemented in conjunction with features from any other approach listed herein, such as those described with reference to the other FIGS. Of course, however, such plot 500 and others presented herein may be used in various applications and/or in permutations which may or may not be specifically described in the illustrative approaches listed herein. Further, the plot 500 presented herein may be used in any desired environment.

It may be prefaced that the plot 500 includes results of implementing the novel techniques described herein in cybersecurity systems for identifying malicious cybersecurity events before they occur. The plot 500 of FIG. 5A is for illustrative purposes zoomed in FIG. 5B. The plot 500 contrasts a true positive rate (recall), e.g., see y-axis, with a false positive rate, e.g., see x-axis. In this implementation, malicious cybersecurity events are predicted one hour ahead of such malicious cybersecurity events being detected by an EDR cybersecurity system. It should be noted that, depending on the approach, parameters of the implementation may be adjusted depending on a tolerance of false alarms. In other words, as an accuracy of predicting malicious cybersecurity events before they occur increases, a number of false alarms, e.g., identification of something considered to be suspicious and/or an anomaly that ends up not being a malicious cybersecurity event, may also increase. Accordingly, in some approaches, input may be received, e.g., from a host device, that indicates that relatively too many false positives, e.g., false alarms, are being detected, and in response thereto, a predetermined threshold that is compared with the classification in the form of a numerical score that is output by the second model may be dynamically adjusted, e.g., dynamically increased a predetermined amount. For example, such adjustments may be performed according to a predetermined table 552 that includes a plurality of different potential tolerances. In contrast, in response to a predetermined condition being met, the predetermined threshold may be dynamically decreased a predetermined amount. Such a predetermined condition may include, e.g., processing resources of the host device exceeding a predetermined threshold, a cybersecurity event being experienced by the host device, a request for relatively stricter predictions being received from the host device, etc.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
collecting historical event log data from host devices;
training a first model to convert textual log events of the historical event log data into event embedding vectors;
training a second model to classify whether at least some of the event embedding vectors represent abnormal or potentially malicious behavior, wherein the second model is a hierarchical temporal event transformer model; and
deploying the trained first model and the trained second model to predict a likelihood of a malicious cybersecurity event occurring within a first predetermined period of time from a current time.

2. The computer-implemented method of claim 1, wherein the first model is trained to use natural language modeling to map tokens of the textual log events of the historical event log data to the event embedding vectors via a lookup table.

3. The computer-implemented method of claim 2, wherein the first model is a bidirectional encoder representations from transformers (BERT) model, wherein training the first model includes using masked-language modeling.

4. The computer-implemented method of claim 1, wherein the first model is different than the second model, wherein the second model is trained in two phases, wherein training of the second model during the first phase includes: determining a subset of the event embedding vectors of the first model to use as training targets, and causing the second model to estimate whether events associated with the training targets will occur within a second predetermined period of time from a current time.

5. The computer-implemented method of claim 4, wherein training of the second model during the second phase includes: determining labeled examples, and causing the second model to classify whether each of the labeled examples represent abnormal or potentially malicious behavior.

6. The computer-implemented method of claim 5, wherein a first of the labeled examples is based on an anomaly, wherein a second of the labeled examples is based on detected malicious activities.

7. The computer-implemented method of claim 1, wherein the second model employs a neural-network architecture.

8. The computer-implemented method of claim 1,
wherein deployment of the trained first model includes:
causing the trained first model to determine, for each of the host devices, embedding vectors for a recent logged event stream; and
generating a two-dimensional matrix that is based on the determined embedding vectors for the recent logged event stream,
wherein deployment of the trained second model includes:
causing the two-dimensional matrix to be applied to the trained second model to generate a classification output that represents the likelihood, wherein the classification output is a numerical score of a predetermined range of potential numerical scores.

9. A computer program product, the computer program product comprising a computer readable storage medium having program instructions embodied therewith, the program instructions readable and/or executable by a computer to cause the computer to:
collect historical event log data from host devices;
train a first model to convert textual log events of the historical event log data into event embedding vectors;
train a second model to classify whether at least some of the event embedding vectors represent abnormal or potentially malicious behavior, wherein the second model is a hierarchical temporal event transformer model; and
deploy the trained first model and the trained second model to predict a likelihood of a malicious cybersecurity event occurring within a first predetermined period of time from a current time.

10. The computer program product of claim 9, wherein the first model is trained to use natural language modeling to map tokens of the textual log events of the historical event log data to the event embedding vectors via a lookup table.

11. The computer program product of claim 10, wherein the first model is a bidirectional encoder representations from transformers (BERT) model, wherein training the first model includes using masked-language modeling.

12. The computer program product of claim 9, wherein the first model is different than the second model, wherein the second model is trained in two phases, wherein training of the second model during the first phase includes: determining a subset of the event embedding vectors of the first model to use as training targets, and causing the second model to estimate whether events associated with the training targets will occur within a second predetermined period of time from a current time.

13. The computer program product of claim 12, wherein training of the second model during the second phase includes: determining labeled examples, and causing the second model to classify whether each of the labeled examples represent abnormal or potentially malicious behavior.

14. The computer program product of claim 13, wherein a first of the labeled examples is based on an anomaly, wherein a second of the labeled examples is based on detected malicious activities.

15. The computer program product of claim 9, wherein the second model employs a neural-network architecture.

16. The computer program product of claim 9,
wherein deployment of the trained first model includes:
causing the trained first model to determine, for each of the host devices, embedding vectors for a recent logged event stream; and
generating a two-dimensional matrix that is based on the determined embedding vectors for the recent logged event stream,
wherein deployment of the trained second model includes:
causing the two-dimensional matrix to be applied to the trained second model to generate a classification output that represents the likelihood, wherein the classification output is a numerical score of a predetermined range of potential numerical scores.

17. A system, comprising:
a processor; and
logic integrated with the processor, executable by the processor, or integrated with and executable by the processor, the logic being configured to:
collect historical event log data from host devices;
train a first model to convert textual log events of the historical event log data into event embedding vectors;
train a second model to classify whether at least some of the event embedding vectors represent abnormal or potentially malicious behavior, wherein the second model is a hierarchical temporal event transformer model; and
deploy the trained first model and the trained second model to predict a likelihood of a malicious cybersecurity event occurring within a first predetermined period of time from a current time.

18. The system of claim 17, wherein the first model is trained to use natural language modeling to map tokens of the textual log events of the historical event log data to the event embedding vectors via a lookup table.

19. The system of claim 18, wherein the first model is a bidirectional encoder representations from transformers (BERT) model, wherein training the first model includes using masked-language modeling.

20. The system of claim 17, wherein the first model is different than the second model, wherein the second model is trained in two phases, wherein training of the second model during the first phase includes: determining a subset of the event embedding vectors of the first model to use as training targets, and causing the second model to estimate whether events associated with the training targets will occur within a second predetermined period of time from a current time.
